(19) United States
(12) Patent Application Publication
(10) Pub. No.: US 2016/0263992 A1
(43) Pub. Date: Sep. 15, 2016

(54) Filler Head

(71) Applicant: MAGNA STEYR Fuel Systems GesmbH, Sinabelkirchen (AT)

(72) Inventors: René HENDLER, Graz (AT); Harald PALLAVER, St. Josef (AT)

(21) Appl. No.: 15/063,956

(22) Filed: Mar. 8, 2016

(30) Foreign Application Priority Data
Mar. 9, 2015 (EP) 15158199.8

(51) Int. Cl. B60K 15/04

(52) U.S. Cl. CPC B60K 15/04

(57) ABSTRACT

A filler head for a fuel tank. The filler head may include at least two separate components: a housing outer surface having a connection opening; and a housing base for connection to the housing outer surface, the housing base having a filler pipe opening to connect to a filler pipe.

### CROSS-REFERENCE TO RELATED APPLICATIONS

The present application claims priority 35 U.S.C. §119 to European Patent Publication No. EP 15158199.8 (filed on Mar. 9, 2015), which is hereby incorporated by reference in its entirety.

### TECHNICAL FIELD

Embodiments relate to a filler head for a fuel tank.

### BACKGROUND

Filler heads, in particular, in motor vehicle production, are inserted at one end of a filler pipe for refuelling a fuel tank arranged at an opposing end of the filler pipe. The filler head serves primarily for inserting a fuel pump nozzle when refuelling the fuel tank. It is also known to pass ventilation lines out of a filler head, in particular, for ventilation when refuelling the fuel tank.

German Patent Publication No. DE 10 2008 061 264 A1 discloses, for example, a fuel tank with a filler pipe and with a ventilation line which is connected to a filler head of the filler pipe.

Filler heads always have a filler pipe opening for connecting to a filler pipe and may have a connection opening in order to be able to connect, in particular, a ventilation line to the filler head.

As filler heads are generally not constructed to be completely radially symmetrical, an alteration to the position of the connection opening, for example when producing the filler heads for different vehicle types, is not always simple and, for example, may require an alteration to the position of the filler pipe or an alteration to the production tools which is undesirable.

### SUMMARY

Embodiments relate to a filler head that may be easily modified for different vehicle types and, in particular, permits different positions of a connection opening and at the same time avoids the aforementioned drawbacks.

In accordance with embodiments, a filler head for a fuel tank may include at least one of the following: a housing outer surface; a housing base; a filler pipe opening formed in the housing base to connect the filler head to a filler pipe; and a connection opening formed in the housing outer surface, wherein the housing base is a different component from the housing outer surface.

In accordance with embodiments, a filler head for a fuel tank may include at least one of the following: a housing outer surface having a connection opening; and a housing base for connection to the housing outer surface, the housing base having a filler pipe opening to connect to a filler pipe.

In accordance with embodiments, a filler head for a fuel tank may include at least one of the following: a housing outer surface having a first end and a second end opposite to the first end; a connection opening formed in the housing outer surface to receive a ventilation nipple; a housing base for connection to the housing outer surface at the first end; and a filler pipe opening formed in the housing base to receive a filler pipe.

In accordance with embodiments, a filler head for a fuel tank may include at least one of the following: a housing outer surface having a first end and a second end opposite to the first end; a connection opening formed in a sidewall of the housing outer surface to receive a connecting piece; a housing base for connection to the housing outer surface at the first end; a filler pipe opening formed in the housing base to receive a filler pipe; and a closure base for connection to the housing outer surface at the second end.

In accordance with embodiments, the housing of a filler head includes at least two parts: a base part; and an outer surface, in particular, having a shape or cross-section of an outer surface of a cylinder or a truncated cone. In accordance with embodiments, the housing outer surface may naturally also have a different geometric cross-section, such as, for example, an oval cross-section, and may also have edges and/or shaped portions.

In accordance with embodiments, the housing outer surface may also comprise a plurality of lateral openings, instead of just one connection opening.

In accordance with embodiments, the housing base may be a single, substantially flat, preferably disk cross-sectioned, component in which the filler pipe opening is formed.

In accordance with embodiments, the housing base and the housing outer surface are two different and separate components, and thus, are not designed in one piece. As a result, the housing outer surface together with the connection opening configured therein may be rotated relative to the housing base, at least before the connection of the housing base and the housing outer surface. Consequently, when producing the filler head, the position of the connection opening may be altered without altering the region of the housing base at the same time.

In accordance with embodiments, the housing base and the housing outer surface may be connected together so as to be separable from one another. Alternatively, the housing base and the housing outer surface may be connected together so as not to be separable from one another, for example, by a welded connection.

In accordance with embodiments, the housing outer surface and the housing base, in particular, the entire filler head, may be composed of a polymeric material or a metallic material. Alternatively, the housing outer surface may be composed of a polymeric material, and the housing base may be composed of a metallic material, or vice versa.

In accordance with embodiments, the filler pipe opening is configured eccentrically in the housing base. In this case, no rotational symmetry is provided in the region of the housing base, and thus, the separation between the housing base and the housing outer surface is particularly advantageous.

In accordance with embodiments, the filler head comprises a closure base which is connected to the housing outer surface. The closure base is thus also an individual component which is initially separate. The closure base may also have the shape or cross-section of an outer surface of a cylinder or a truncated cone, in particular, with approximately the same radius as the housing outer surface.

In accordance with embodiments, the closure base in the joint region with the housing outer surface has the same geometry as said housing outer surface. The closure base may have a bayonet closure for receiving a cap.

In accordance with embodiments, the connection opening in the housing outer surface may be configured to receive a connecting piece such as, for example, a ventilation nipple.

### DRAWINGS

Embodiments will be illustrated by way of example in the drawings and explained in the description below.

FIG. 1a and 1b illustrate an exploded view and a perspective view of a filler head, in accordance with embodiments.

FIG. 2 illustrates a plan view of a filler head, in accordance with embodiments.

FIG. 3 illustrates a sectional view from cutting line A-A of FIG. 2, in accordance with embodiments.

FIG. 4 illustrates a bottom view of a filler head from the side remote from the filler pipe, in accordance with embodiments.

### DESCRIPTION

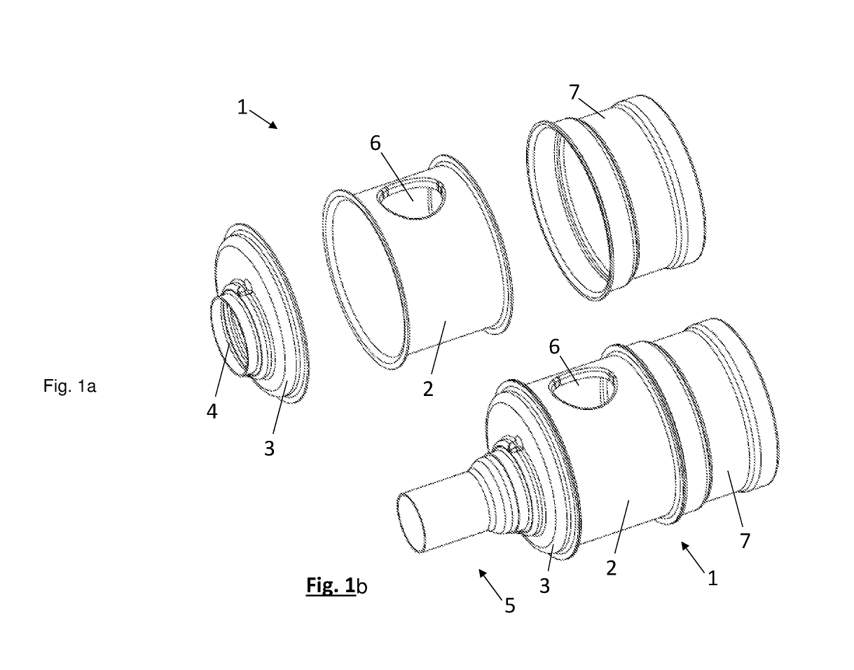

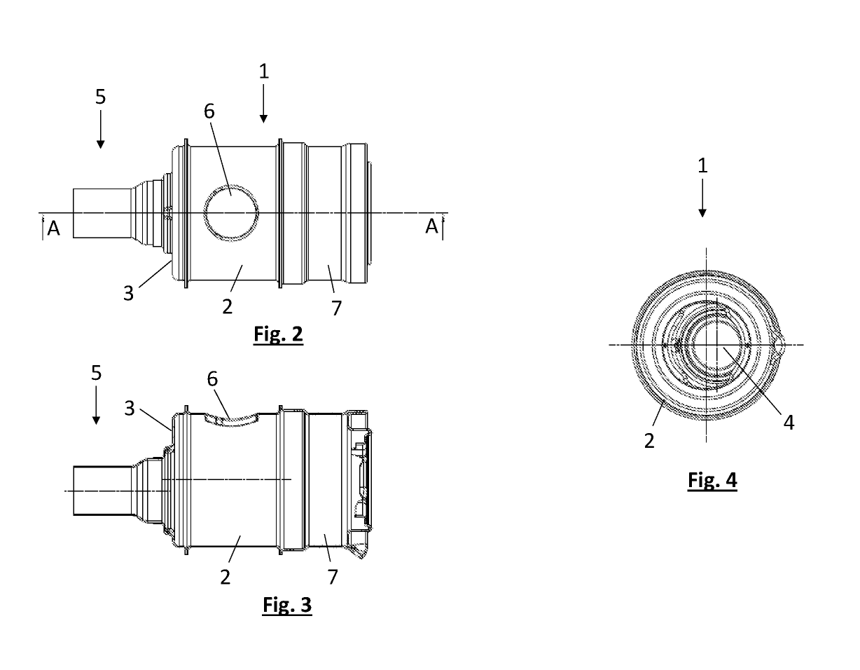

As illustrated in FIGS. 1-4, a filler head 1 in accordance with embodiments for connection to one end of a filler pipe 5. The filler head 1 has an intermediate housing or housing outer surface 2, and a housing base 3. A filler pipe opening 4 is formed in the housing base 3 for connecting the filler head 1 to a filler pipe 5. A connection opening 6 is formed in a sidewall of the housing outer surface 2 to receive a another ventilation nipple (not illustrated). The connection opening 6 substantially forms a hole on one side of the housing outer surface 2 and, therefore, is rotated therewith when the housing outer surface 2 is rotated. The housing base 3 and the housing outer surface 2 are separate components, and are, thus may be separate before assembly.

The filler head 1 additionally has a closure base 7 which is also produced as a separate component and which is connected to the housing outer surface 2 at an opposite end of the housing base 3. The closure base 7 has substantially the same cylinder surface geometry as the housing outer surface 2. The closure base 7 and the housing outer surface 2 may have the same geometry, at least at the joint thereof. The housing outer surface 2 and the closure base 7 may also be configured as a single component. In the closure base 7, a closure element for the filler head 1 is received or is able to be fastened thereto.

As illustrated in FIGS. 3 and 4, the filler pipe opening 4 may be configured eccentrically in the housing base 3. As illustrated in FIGS. 1 a and 1 b, the housing outer surface 2 may be rotated relative to the housing base 3 at least during the production process before connecting to the housing base 3, so that the position of the connection opening 6 and/or a ventilation nipple connected thereto may be altered, without changing the spatial position of the filler head 1.

The term “coupled” or “connected” may be used herein to refer to any type of relationship, direct or indirect, between the components in question, and may apply to electrical, mechanical, fluid, optical, electromagnetic, electromechanical or other con-nections. In addition, the terms “first,” “second, etc. are used herein only to facilitate discussion, and carry no particular temporal or chronological significance unless other-wise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SIGNS

1 Filler head

2 Housing outer surface

3 Housing base

4 Filler pipe opening

5 Filler pipe

6 Connection opening

7 Closure base

What is claimed is:

1. A filler head for a fuel tank, the filler head comprising:
a housing outer surface having a connection opening; and
a housing base for connection to the housing outer surface, the housing base having a filler pipe opening to connect to a filler pipe.

2. The filler head of claim 1, wherein the housing base and the housing outer surface are connected together so as to be separable from one another.

3. The filler head of claim 1, wherein the housing base and the housing outer surface are fixedly connected together so as to be inseparable from one another from one another.

4. The filler head of claim 1, wherein the filler pipe opening is configured eccentrically in the housing base.

5. The filler head of claim 1, further comprising a closure base for connection to the housing outer surface.

6. The filler head of claim 1, wherein the connection opening is configured for receiving a ventilation nipple.

7. The filler head of claim 1, wherein the housing outer surface is composed of a first material.

8. The filler head of claim 7, wherein the housing base is composed of a second material.

9. The filler head of claim 8, wherein the second material is different than the first material.

10. The filler head of claim 8, wherein the second material is the same as the first material.

11. A filler head for a fuel tank, the filler head comprising:
a housing outer surface having a first end and a second end opposite to the first end;
a connection opening formed in the housing outer surface to receive a ventilation nipple;
a housing base for connection to the housing outer surface at the first end; and
a filler pipe opening formed in the housing base to receive a filler pipe.

12. The filler head of claim 11, wherein the housing base and the housing outer surface are connected together so as to be separable from one another.

13. The filler head of claim 11, wherein the housing base and the housing outer surface are fixedly connected together so as to be inseparable from one another from one another.

14. The filler head of claim 11, wherein the filler pipe opening is configured eccentrically in the housing base.

15. The filler head of claim 11, further comprising a closure base for connection to the housing outer surface at the second end.

16. The filler head of claim 11, wherein the housing outer surface is composed of a first material.

17. The filler head of claim 16, wherein the housing base is composed of a second material.

18. The filler head of claim 17, wherein the second material is different than the first material.

19. The filler head of claim 17, wherein the second material is the same as the first material.

20. A filler head for a fuel tank, the filler head comprising:
a housing outer surface having a first end and a second end opposite to the first end;
a connection opening formed in a sidewall of the housing outer surface to receive a connecting piece;
a housing base for connection to the housing outer surface at the first end;
a filler pipe opening formed in the housing base to receive a filler pipe; and
a closure base for connection to the housing outer surface at the second end.
